(19) United States
(12) Patent Application Publication
(10) Pub. No.: US 2025/0210011 A1
(43) Pub. Date: Jun. 26, 2025

(54) QUICK-TO-DISMANTLE, RECONFIGURABLE STRINGED MUSICAL INSTRUMENT

(71) Applicant: Francois LUC, Paris (FR)

(72) Inventor: Francois LUC, Paris (FR)

(21) Appl. No.: 18/850,396

(22) PCT Filed: Apr. 2, 2023
(86) PCT No.: PCT/EP2023/058598

§ 371 Date: Sep. 24, 2024

(30) Foreign Application Priority Data
May 8, 2022 (FR) FR2204343

(51) Int. Cl. G10D 3/095; G10D 1/08

(52) U.S. Cl. CPC G10D 3/095; G10D 1/085

(57) ABSTRACT

The invention relates to a musical instrument having plucked strings, in particular an electric guitar or bass, the neck of which can be quickly dismantled and stored in a groove located in the front face of the body, in line with the strings of the instrument. allowing the instrument to be transported in a compact case.

Various elements are positioned in the groove: bridge, tailpiece and microphones. These elements are removed from the groove when the instrument is dismantled, leaving room for the neck and allowing the instrument to be stored in the smallest possible thickness. This allows for different configurations in terms of the choice of microphones, bridge and tailpiece, which can be easily interchanged to obtain different ranges of sound depending on the repertoire and musical tastes of the musician.

### FIELD OF THE INVENTION

The invention relates to the field of plucked string musical instruments and in particular that of basses or electric guitars.

### BACKGROUND OF THE INVENTION

In 1951, Clarence “Leo” Fender revolutionized the electric guitar (reference 1) with the invention of the Telecaster which was the first “solid body” guitar—that is to say without a hollow sound box—which could be produced industrially in large quantities. Leo Fender was inspired by automobile production and designed a guitar that could be produced quickly from independently manufactured subassemblies: body, neck, microphone and bridge (reference 2). This favored the rapid development of electric guitars which could then be produced in hundreds of thousands of units per year.

A drawback of electric guitars is their length, of the order of a meter, which makes them challenging to carry—particularly by plane—unless they are stored in extremely reinforced protective cases and carefully wrapped in shock-absorbing material in order to allow transporting them as checked luggage while minimizing the risk of breakage of the instrument. The passionate guitarist must therefore frequently give up carrying his instrument with him when traveling by plane. The same goes for traveling on a motorcycle or bicycle, which can be dangerous with a large instrument.

The emergence of headless guitars (reference 3) has made it possible to make guitars more compact but the length remains around 75 cm for a standard scale of 64.8 cm (25.5 inches) which is the most common string length for guitars.

It is then necessary to use a guitar with a reduced scale to obtain a total length of less than 65 cm which can fit diagonally into a cabin luggage on an airplane. Using a smaller scale has the effect of reducing the spacing between notes. This can be uncomfortable and unsettling for guitarists used to playing on a standard-sized scale.

The alternative is then to disassemble the guitar by separating the body and the neck. Some rapid mechanisms have been proposed for this purpose (reference 4). Alternatively, other concepts have been proposed aimed at folding the neck over the body of the guitar (reference 5).

The drawback of this method is that the thickness of the neck adds up to the thickness of the body and that the guitar thus disassembled, if it can fit in cabin luggage, will take up a lot of space, leaving little space to carry other items.

Some also suggest storing the neck in a cavity located inside the body (reference 4): this approach, although it does indeed save a little space, supposes using a sufficiently thick body so that the cavity receiving the neck does not intercept the volume occupied by the microphones. This type of approach requires the use of a thickness greater than that usually used for an electric guitar body and therefore remains non-optimal for the guitarist looking to travel with a compact instrument.

### SUMMARY OF THE INVENTION

The present invention relates to the production of a plucked string musical instrument—and in particular a bass or an electric guitar—whose neck can be dismantled and stored in a groove located on the front face of the body, in the axis of the strings of the instrument. It is thus possible to transport the instrument in a compact luggage. This also minimizes the thickness occupied by the instrument when it is disassembled and thus leaves room in the luggage for other items.

When assembling the instrument, various elements are positioned in the groove: bridge, tailpiece, and microphones. These elements are removed from the groove during disassembly, thus leaving room for the neck and allowing storage of the instrument in a minimal thickness. This also has the advantage of allowing different configurations of the instrument, in terms of choice of microphones, bridge and tailpiece, which can thus be easily interchanged to obtain different palettes of tones depending on the repertoire and musical tastes of the musician.

The assembly and disassembly of the neck can be carried out by an arrangement of stops and a single nut, thus allowing this operation to be carried out quickly without the need to modify the tension of the strings at their ends.

An optimized body shape allows storage with the neck in the diagonal in a compact rectangular format, without change in the ergonomics of the instrument, while leaving space to store the various accessories.

### BRIEF DESCRIPTION OF THE DRAWINGS

FIG. 1A: front view and side view (FIG. 1B) of the instrument highlighting the groove dug in the front of the body and intended to receive the neck during transport and the tailpiece bridge as well as the microphones while in playing position.

FIG. 2: illustration of the tailpiece bridge and one of the instrument's microphones fixed on a throught-cavity support intended to be inserted along the rails equipping the groove.

FIG. 3: illustration of one of the microphones of the instrument fixed on a support intended to be inserted along the grooves with which the groove is equipped.

FIG. 4A: view of the heel of the neck and sectional view (FIG. 4B) showing the arrangement allowing the attachment of the neck to the body using a single bolt,

FIG. 5A: illustrations showing respectively the assembled instrument seen from the front ready to play and the instrument in side view with the neck in the transport position in its groove (FIG. 5B) once the accessories—microphones and tailpiece bridge—disassembled.

FIG. 6: presentation of a guitar according to the invention with an optimized body shape allowing storage in a compact luggage.

### DETAILED DESCRIPTION OF THE INVENTION

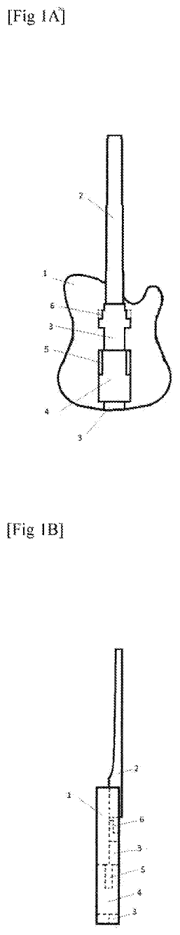

One embodiment of the invention is presented [FIG. 1A] in front view and consists of a plucked string instrument, in this case an electric guitar, comprising a body (1) comprising a pocket in which is fixed mechanically the neck (2) via a heel.

The body on the side of the strings—intended to be played—has over its entire length a groove (3), parallel to the strings, in the axis of the neck, whose depth is at least equal to the embedding thickness of the neck and whose width is at least equal to the width of the neck [FIG. 1B].

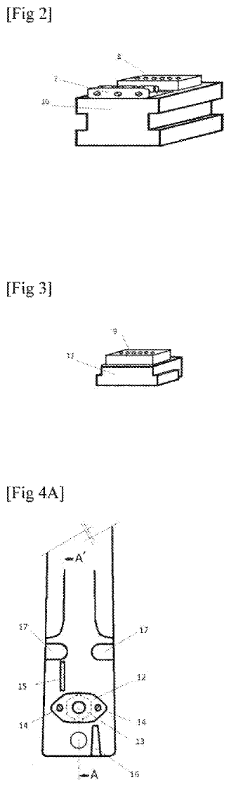

The various elements of the instrument located on the body and under the strings—tailpiece bridge (7), microphones (8) (9)—are removable in order to clear the groove over its entire length. They are represented [FIG. 2] and [FIG. 3].

The groove (3) is locally widened and dug to accommodate the different elements.

The elements getting through the body or subjected to the tension of the strings are fixed using two rails (5)—or alternatively two grooves—parallel to the main body groove and serving as guides. An opening (4) is made upstream of the rails (or grooves) relative to the neck, in order to be able to insert or remove the said elements—bridge, tailpiece or tailpiece bridge—and to position them by sliding along the rails (or grooves) up to stops located upstream, which then makes it possible to hold the strings.

To this end, the bridge and the tailpiece—to which one or more microphones can be added—are fixed on a support (10) intended to slide along the guides. The microphones are also equipped with plug-in connectors along an axis parallel to the groove and allowing electrical contact to be established with the body of the instrument at the stops.

The use of guides as fixing mode can also be implemented when the microphones are attached to non-through supports (11) and are not subject to the tension of the strings, their maintenance in position in the guide (6) then being ensured by the connector.

An alternative method of positioning microphones may be to attach them with magnets.

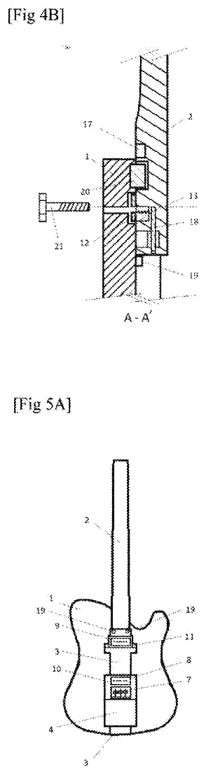

The neck can be quickly disassembled with a bolt—possibly hand-tightened—passing through the body on the one hand; and a metal plate (12) comprising a single nut (13) centered on the axis of the neck and fixed to the heel of the neck by two screws (14) placed on either side of the nut, symmetrically with respect to the axis of the neck. Such an arrangement is shown in sectional view [FIG. 4B] and allows the nut to be firmly anchored in the heel while remaining at a distance from the metalic constraint rod (18)—commonly called “truss rod”—intended to control the curvature of the neck and placed on the axis of the neck—buried about ten millimeters inside the neck on the side of the face opposite the strings.

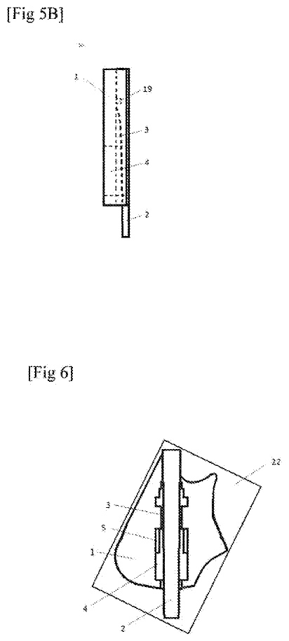

The groove has two lateral stops (19), shown [FIG. 5A], which allow the neck to be wedged longitudinally in relation to the body and to pivot it, along an axis perpendicular to the axis of the groove and parallel to the plane of the strings, thus allowing the strings to be released during disassembly or to be put back under tension when reassembling the neck.

The width of the groove at the heel is precisely adjusted to the width of the heel. When the body is symmetrical with respect to the neck and the heel is rectangular, the two stops and the groove are sufficient to provide effective wedging of the neck. When the body has a cutaway intended to allow easier access to the higher notes, as is the case in the illustrations shown, a metal rail (20) of centimeter length is inserted on the body, parallel to the neck axis and perpendicular to the plane of the body, and placed at the end of the groove in the vicinity of the cutaway. A slot (15), judiciously placed in the neck to precisely receive the rail, provides good lateral wedging of the neck. The parallelism of the rail with the axis of the neck allows the rotation of the neck around the axis of the stops for the assembly and disassembly of the neck. As illustrated [FIG. 4A], a second slot (16) and two cavities (17) are positioned on the back of the neck to receive the rail and the stops respectively when the neck is disassembled and rotated 180 degrees to be stored in the groove. Unlike the slot (15) which is precisely adjusted to the dimension of the rail, the second slot (16) and the cavities (17) are widened to give sufficient play to facilitate the storage of the neck.

Alternatively, a more conventional arrangement, using four screws through the body, can be used in addition to the stops to secure the neck in place of the arrangement described above. However, this has the disadvantage of requiring more time for assembly and disassembly as well as deteriorating in the time. over the course of successive assemblies and disassemblies.

Once the single bolt (21) is unscrewed, the neck can then be rotated towards the front of the body—thus releasing the tension on the strings—then separated from the body and rotated approximately 180 degrees in the plane of the strings to be stored in the groove—with the back of the neck towards the body—after removing the tailpiece and pickups as shown [FIG. 5B].

This allows for compact storage of the instrument at a thickness approximately equal to the thickness of the body (rather than the thickness of the body plus the thickness of the neck as per the methods described in the previous state of the art).

This also has the advantage of being able to interchange more easily different types of bridges and tailpieces—for example separate bridge and tailpiece or tailpiece with vibrato—as well as using different types of microphones.

Reassembly is done by rotating the neck 180 degrees around its axis so that the fingerboard faces the body and then lifting it from the groove to place it roughly perpendicular to the body. It is then possible to position the microphones and the tailpiece bridge in the guides and then, by placing the heel of the neck resting on the stops (19), to pivot the neck backwards until it is positioned parallel to the body with the rail (20) inserted in the slot (15). This movement allows the strings to be tensioned and it is then sufficient to immobilize the neck by placing the bolt (21) through the body in contact with the nut (13) and tightening it.

In particular, a headless neck solution allows a guitar with a 25.5-inch scale and 24 frets to fit into a 55 cm×35 cm×20 cm suitcase compatible with most airlines (reference 6).

An optimized body shape is shown [FIG. 6]. It consists of modifying the classic shape of the guitar by reducing the depth of the cutaway and removing the part of the small lobe of the body located between the junction with the large lobe and the bottom of the neck on the side of the bass strings as well as the lower part of the large lobe of the body of the guitar on the side of the treble strings. Such geometry makes it possible to preserve the essential elements of the ergonomics of a stringed instrument, namely the support surface of the player's arm at body level and the distance between the player's leg in a seated position and the strings. This geometry allows the neck to be stored diagonally inside an even smaller piece of luggage (22), sometimes required by some low-cost airlines.

This type of arrangement can also make it possible to produce an electric bass that can be transported in an extremely compact manner.

### REFERENCES

Reference 1: U.S. Pat. Des. 164,227—Clarence L. Fender—August, 14 1951
Reference 2: U.S. Pat. No. 2,573,254—Combination Bridge and Pick-up Assembly for String Instruments—Clarence L. Fender—October, 30 1951
Reference 3: U.S. Pat. Des. 290,130—Electric Guitar with Bolt-on Neck—Ned Steinberger—June, 2 1987
Reference 4: U.S. Pat. No. 5,353,672—Collapsible Guitar with Quick Disconnect Neck and Submerged String Tunnels—Lelland W. Stewart—October, 11 1994
Reference 5: U.S. Pat. No. 8,273,974 B1—Folding Mechanism for Bolt-on Neck Stringed Instruments—Eduardo Edison Gonzalez—September, 25 2012
Reference 6: Cabin baggage size for different airlines https://www.taillecabine.com/compagnies/taille-bagages-cabine.php

1. A plucked string musical instrument comprising:
a) a body comprising a pocket to receive a neck,
b) a straight neck mechanically fixed to the body at the level of a heel inserted into the pocket,
c) a groove dug on the playing face of the body of the instrument, along an axis parallel to the axis of the neck, over the entire length of the body, starting from the pocket, over a width at least equal to the width of the pocket and a depth at least equal to the depth of the pocket,
d) a cavity made in the groove, wider than the groove and equipped laterally with mechanical guides parallel to the axis of the groove and of a length less than the length of the cavity, allowing, once the tension of the strings is released, the tailpiece and the bridge of the instrument to slide backwards relative to the neck until they pass the end of the guides and thus to be able to separate the tailpiece and the bridge from the body of the instrument by removing them from the cavity.
Said musical instrument also having the following characteristics:
a) the groove has two lateral stops allowing the neck to be wedged longitudinally in relation to the body and to pivot it along an axis parallel to the plane of the strings and perpendicular to the axis of the neck in order to release tension from the strings when removing the neck and to put them back under tension when reassembling the neck.
b) the back of the neck has two cavities intended to receive the stops when the neck is turned 180 degrees in the plane of the strings and then placed inside the groove with the back of the neck towards the body of the instrument.

2. A musical instrument according to claim 1:
a) whose heel is equipped with a plate mechanically fixed so as to retain a nut buried in the heel while allowing access to the screw thread of the nut,
b) whose body is pierced with a single hole allowing the neck to be fixed by means of a bolt screwed into the nut buried in the heel.

3. A musical instrument according to claim 2:
a) whose body has a cutaway at the junction with the neck on the side of the treble strings
b) whose body pocket is equipped with a rail parallel to the axis of the neck and perpendicular to the plane of the body,
c) whose heel is provided with a slot intended to receive the rail precisely in order to provide lateral wedging of the neck and another slot intended to receive the rail when the neck is turned 180 degrees in the plane of the strings and placed inside the groove, the back of the neck towards the body of the instrument.

4. A musical instrument according to claim 1 which is an electric instrument whose microphones are placed inside the groove when mounting the neck and removed when dismounting the neck.

5. A musical instrument according to claim 4:
a/ characterized in that it is a guitar,
b/ whose small lobe of the body has a wide, shallow cutaway at the bottom of the neck on the side of the treble strings,
c/ of which the part of the small lobe of the body located between the junction with the large lobe and the bottom of the neck, on the side of the bass strings, has been removed,
d/ of which the lower part of the large lobe of the body of the instrument on the side of the treble strings has been removed.

6. A musical instrument according to claim 4:
a/ characterized in that it is a bass,
b/ whose small lobe of the body has a wide, shallow cutaway at the bottom of the neck on the side of the treble strings,
c/ of which the part of the small lobe of the body located between the junction with the large lobe and the bottom of the neck, on the side of the bass strings, has been removed,
d/ of which the lower part of the large lobe of the body of the instrument on the side of the treble strings has been removed.
